(19) United States
(12) Patent Application Publication
(10) Pub. No.: US 2007/0132773 A1
(43) Pub. Date: Jun. 14, 2007

(54) Multi-stage memory buffer and automatic transfers in vehicle event recording systems

(75) Inventor: James Plante, Del Mar, CA (US)

Correspondence Address: SMARTDRIVE SYSTEMS, INC., P.O. BOX 757, LA JOLLA, CA, 92038, US

(73) Assignee: SmartDrive Systems Inc

(21) Appl. No.: 11/297,669

(22) Filed: Dec. 8, 2005

(51) Int. Cl. G06F 12/00

(52) U.S. Cl. 345/564

(57) ABSTRACT

Vehicle event recorder systems are arranged with three stage memories and special mechanism to manage those memories including transfer of data there between. Namely, a managed loop memory receives data from a video camera in real-time and continuously overwrites expired data implicitly determined no longer useful. Data in a managed loop memory is only passed to a more stable memory, a high-capacity buffer memory, in response to an event having occurred. An event trigger produces a signal, which causes data transfer between the managed loop memory and an on-board, high-capacity buffer memory. The high-capacity buffer memory is suitable for storing video series associated with a plurality of events. Finally, a permanent data store is arranged to receive data from the high-capacity buffer memory whenever the system returns and falls within a predetermined proximity of a download station.

### BACKGROUND OF THE INVENTIONS

1. Field

The following inventions disclosure is generally concerned with memory management in video event recorder systems and specifically concerned with a multi-stage memory strategy which permits highly automated data transfer with maximized efficiency for application-specific configurations.

2. Prior Art

Inventor Schmidt presents in U.S. Pat. No. 5,570,127, a video recording system for a passenger vehicle, namely a school bus, which has two video cameras one for an inside bus view and one for a traffic view, a single recorder, and a system whereby the two cameras are multiplexed at appropriate times, to the recording device. Schmidt suggests using video recording devices having video input ports, which are well known to skilled artisan. He does not include any for proposal for unique memory management; but rather clearly indicates that the known memories which are suitable for general-purpose video recording are similarly suitable for his inventions.

Thomas Doyle of San Diego, Calif. and QUALCOMM Inc. also of San Diego, present an invention for a method and apparatus for detecting fault conditions in a vehicle data recording device to detect tampering or unauthorized access, in U.S. Pat. No. 5,586,130. The system includes vehicle sensors for monitoring one or more operational parameters of the vehicle. Inventor Doyle includes non-volatile RAM as part of his system for handling all memory function. While non-volatile RAM is highly useful in most applications, non-volatile RAM has certain lifetime issues when the number of rewrites is very high.

A “computerized vehicle log” is presented by Dan Kikinis of Saratoga Calif. in U.S. Pat. No. 5,815,093. The vehicle accident recording system employs a digital camera connected to a controller in non-volatile memory, and an accident sensing interrupter. These systems include complex relationships between a plurality of memories. Kikinis' systems include program memory ROM, RAM, data memory, multi-sectored flash memory, memory tapes, disk drives, among others. In the non-volatile memory, oldest images are overwritten by newer images until an accident is detected. At that time, the memory is blocked from further overwrites. Mr. Kikinis instructs that in preferred embodiments, the system has a communications port whereby stored images are downloaded after an accident to a digital device capable of displaying images. This feature is described in greater detail in the specification which indicates download to a server having specialized image handling and processing software thereon. Further at column 5, lines 60 to 67, Kikinis indicates that a user connects an output medium to a transfer terminal and activates vehicle log program software to download data from data memory to the output medium.

A vehicle crash data recorder is presented by inventor Ferguson of Bellaire, Ohio in U.S. Pat. No. 6,185,490. The apparatus is arranged with a three stage memory to record and retain information. And further it is equipped with series and parallel connectors to provide instant on-scene access to accident data. It is important to note that Ferguson finds it important to include the possibility of on-site access to the data. Further, that Ferguson teaches use of a wired connection in the form of a serial or parallel connector. This teaching of Ferguson is common in many advanced systems configured as vehicle event recorders.

A traffic accident data recorder and traffic accident reproduction system and method is presented as U.S. Pat. No. 6,246,933. A plurality of sensors for registering vehicle operation parameters including at least one vehicle mounted digital video, audio camera is included for sensing storing and updating operational parameters. A re-writable, non-volatile memory is provided for storing those processed operational parameters and video images and audio signals, which are provided by the microprocessor controller. Data is converted to a computer readable form and read by a computer such that an accident can be reconstructed via data collected.

U.S. Pat. No. 6,298,290 presented by Abe et al, teach a memory apparatus for vehicle information data. A plurality of sensors including a CCD camera, a collision sensor, vehicle speed sensors, brake pressure sensor, acceleration sensor, are all coupled to a control unit. Further, the control unit passes information to a flash memory and a RAM memory subject to an encoder. Information collected is passed through a video output terminal. This illustrates another hardwire system and the importance placed by experts in the art on a computer hardware interface. This is partly due to the fact that video systems are typically data intensive and wired systems are necessary as they have bandwidth sufficient for transfers of large amounts of data.

U.S. Pat. No. 6,389,339 granted to Inventor Just, of Alpharetta, Ga. teaches a vehicle operation monitoring system and method. Operation of a vehicle is monitored with an on-board video camera linked with a radio transceiver. A monitoring service includes a cellular telecommunications network to view video data received from the transceiver to a home-base computer. These systems are aimed at parental monitoring of adolescent driving. The mobile modem is designed for transmitting live video information into the network as the vehicle travels about its service route.

Inventor Lambert teaches in U.S. Pat. No. 6,421,080 a “digital surveillance system with pre-event recording”. Pre-event recording is important in accident recording systems, because detection of the accident generally happens after the accident has occurred. A first memory is used for temporary storage. Images are stored in the temporary storage continuously until a trigger is activated which indicates an accident has occurred at which time images are transferred to a more permanent memory.

Systems taught by Gary Rayner in U.S. Pat. No. 6,389,340 are directed to cameras for automobiles which capture video images and store the recorded images locally on a mass storage system. An operator, at the end of the vehicle service day, puts a connector into a device port and downloads information into a server system having specialized application software whereby images and other information can be played-back and analyzed at a highly integrated user display interface. Rayner uses a combination of volatile and non-volatile memory to enable his systems.

Notwithstanding, techniques have been discovered which provide very novel arrangements of the memories in vehicle recorder systems, particularly with respect to highly mobile systems party based a light-weight temporary memory.

While systems and inventions of the art are designed to achieve particular goals and objectives, some of those being no less than remarkable, these inventions have limitations which prevent their use in new ways now possible. Inventions of the art are not used and cannot be used to realize the advantages and objectives of inventions taught herefollowing.

### SUMMARY OF THE INVENTIONS

Comes now, James Plante with inventions of a multi-stage memory and automated transfer in vehicle event recording systems including devices and methods. Vehicle event recorder systems are arranged with multi stage memories and special mechanisms to cause transfer of data between those memories. First, a continuous overwrite memory is arranged as a managed loop. That memory receives data from a video camera in real-time and continuously overwrites expired data. Data is expired when according to a timeline definition, the data is expired. Second, data in the managed loop memory is passed to a more stable longer term buffer memory in response to an event having occurred. An event trigger causes a data transfer from the managed loop to the buffer memory. Third, the buffer memory is arranged as an on-board buffer memory suitable for storing data of a video series associated with a plurality of events. Finally, a permanent data store is arranged to receive data from the high-capacity buffer memory whenever the system returns and falls within a predetermined proximity of a download station.

Accordingly, a multi-stage video memory management system includes a managed loop memory, a high-capacity buffer memory, a permanent data store, an event trigger; and a proximity trigger. The managed loop memory is arranged to continuously receive video data from a video camera and record this data in real-time. The high-capacity buffer memory has sufficient capacity to store a plurality of events—in some versions up to 40 separate events can be stored. The event trigger is arranged to cause video data may be transferred from the managed loop memory to the high-capacity buffer memory in response to an event such as a traffic accident. The permanent data store is a mass memory of high durability and capacity suitable for long-term storage. This memory may be coupled to the high-capacity buffer memory such that video data may be transferred from the high-capacity buffer to the permanent data store in response to said proximity trigger. The permanent memory may be arranged as a remote data store in communication with the buffer memory via public communications networks such as the Internet.

### OBJECTIVES OF THESE INVENTIONS

It is a primary object of these inventions to provide novel memory management in vehicle event recorder systems;

It is an object of these inventions to provide systems of high utility and efficiency with regard to various memory types and their particular associated attributes;

It is a further object to provide vehicle event recorders with multistage memory and management systems.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is a schematic which illustrates a multi-stage memory buffer between a camera and remotely located mass storage;

FIG. 2 is an illustration of examples of event trigger actions; and

FIG. 3 is an illustration of a proximity trigger action;

FIG. 4 diagrams a system including a final memory in a remote location;

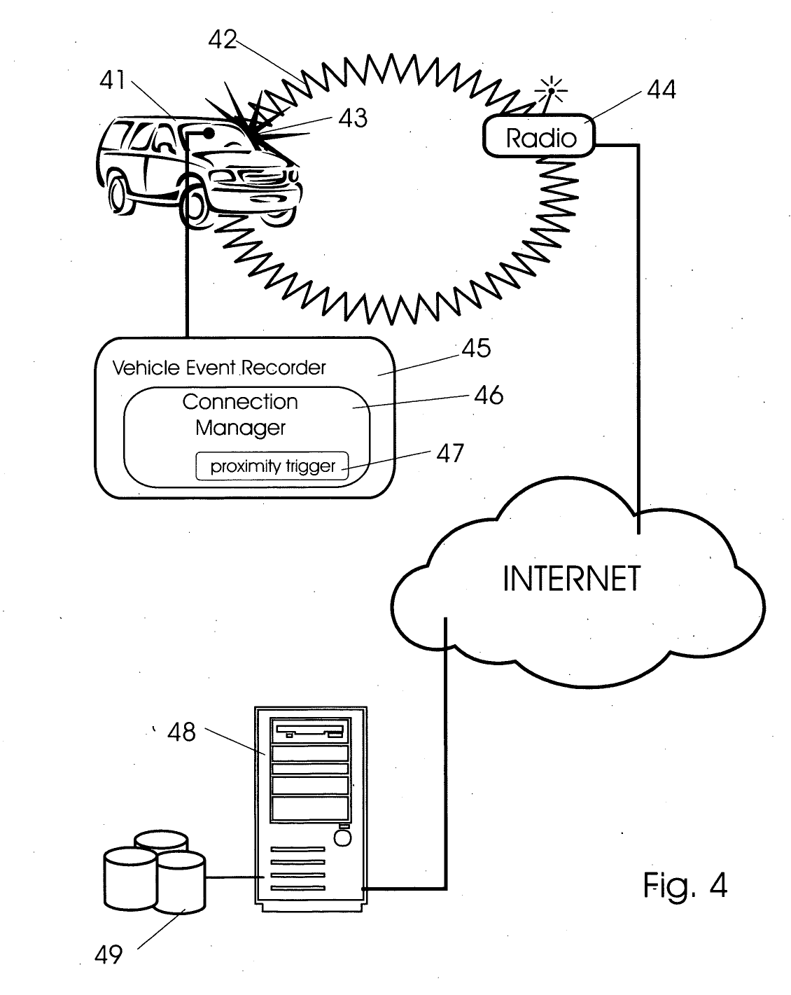

FIG. 5 illustrates a large area communications space used in conjunction with a proximity trigger;

FIG. 6 is a schematic diagram illustrating a proximity trigger event in a large area communications space;

FIG. 7 illustrates two separate communications spaces spatially separated and an authentication system associated with the spaces; and

FIG. 8 is a block diagram directed to preferred apparatus of these inventions.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

Vehicle Event Recorder

A vehicle event recorder is fashioned as an electronic apparatus including video recording equipment, a microprocessor, memory, application-specific programming, and a communications system. A vehicle event recording unit is built into a small housing suitable for mounting within a common vehicle such as a car, truck or bus.

Managed Loop Memory

‘Managed loop memory’ is rewritable memory arranged to receive a continuous input and to continuously record that input in a loop fashion whereby old recorded data is replaced by newly received data.

High Capacity Buffer Memory

‘High-capacity buffer memory’ is memory arranged to receive large data sets, for example those associated with video series images, and to temporarily store those data sets until a time in which they can be transferred to a more permanent memory.

Permanent Data Store

A ‘permanent data store’ is a durable data store of very large capacity, and generally includes connectivity to networks and large distributed advanced data management systems including backup protection schemes.

Event Trigger

An ‘event trigger’ is a system devised to detect a prescribed physical condition and provide an electronic signal in response thereto; the electronic signal being coupled to another system which may be set into action as a result of having received the event trigger signal.

Proximity Trigger

A ‘proximity trigger’ is a system devised to detect a prescribed proximity condition and provide an electronic signal in response thereto; the electronic signal being coupled to another system which may be set into action as a result of having received the proximity trigger signal.

### PREFERRED EMBODIMENTS OF THESE INVENTIONS

In accordance with each of preferred embodiments of these inventions, apparatus for and methods of memory management in vehicle recorder systems are provided. It will be appreciated that each of embodiments described include both an apparatus and method and that the apparatus and method of one preferred embodiment may be different than the apparatus and method of another embodiment.

Vehicle event recorders of these inventions have special memories and configurations of memories. Further, special couplings between these memories are considered important aspects of these inventions. To better understand this, it is useful to review particulars relating to the objectives associated with vehicle recorder systems used in conjunction with automobiles. Vehicle event recorder systems of these inventions are arranged to capture video of brief time periods rather than extended continuous video series. The nature of this type of recording has implications on preferred memory arrangements. Further, as a vehicle is considered a highly mobile system, memories suitable for lightweight, small footprint mobile systems must be considered. Appropriate ‘lightweight’ computing/video and memory systems are preferably used with vehicle on-board systems. Finally, the nature of a vehicle with respect to network connectivity is to be considered.

Unlike common video systems arranged to capture continuous video, vehicle recorder systems are primarily designed to capture certain particular events occurring over very short time periods. For example, in vehicle recorder systems, it is not useful to produce a continuous video record of scenes and events around the vehicle throughout its service day. Rather, only particular events associated with certain vehicle use are of interest. For example, those events associated with vehicle abuse. Further, traffic accidents and other forms of vehicle misuse yield occasions where it is desirable to have a brief video record of the circumstance(s) which led to and resulted from such misuse or accident. Thus the video recorder systems of this disclosure are characterized in that they are intended to capture short video sequences rather than video sequences over extended period of time. This detail has direct implications with regard to choice of memory arrangements. In this case, it is useful to arrange a first memory in a managed loop configuration whereby video is collected in real-time but constantly overwritten with later captured video data. Only when an important event occurs is data preserved by transfer to a high capacity buffer memory.

As it is desirable in a vehicle recorder system that devices be very small and compact in size, certain memories which cannot be easily implemented as compact systems are not appropriate for vehicle event recorders. In example, large disk drive arrays, which have huge capacity and great redundancy, are memory systems not appropriate for these vehicle event recorder systems. However, memory systems commonly know as ‘flash’ type memory are highly useful. A flash type memory can be useful to hold video data associated with a plurality of discrete video events. Thus in preferred versions, a flash type memory buffer is coupled to managed loop memory such that each time an event occurs, data in managed loop memory is transferred to the flash memory. Flash memory having a high-capacity is operable for storing video data associated with many events.

Finally, attention is directed to the nature of communications connectivity associated with a vehicle which includes computing systems. Since vehicles are not readily suited to be ‘plugged into’ wired computer network systems, it is useful to implement special consideration when configuring a memory strategy for vehicle event recorders. Thus, an on-board memory may have a special relationship with a remote network memory. These two memories may be coupled to each other only at specific times, for example, when a vehicle has returned to a download station.

With a better understanding of the vehicle event recording application at hand, one will appreciate that an ideal memory system is more complex than simple deployment of inexpensive flash memory in conjunction with a video camera which is the common arrangement of light-duty video cameras such as inexpensive handheld devices and those used in cell phones. In vehicle recorder systems, it is preferred that we have a three stage memory: comprising: a high-speed, managed to loop memory, a high-capacity buffer memory, and a final durable data store system.

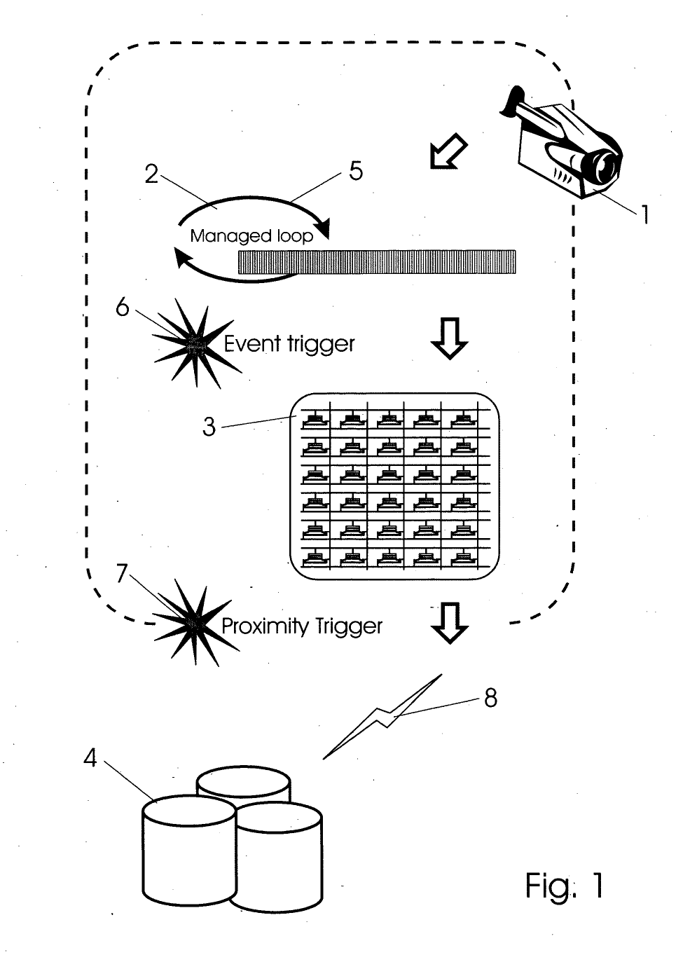

One gains a better understanding of these systems in consideration of the appended drawing figures with associated reference numerals. In particular with reference to FIG. 1, a three stage memory system suitable for vehicle event recorders is presented. A video camera 1, is arranged to capture video images and convert those images to electronic signals which may be processed by a computer and stored in electronic memories. The vehicle event recorder system is comprised of memory systems including: a managed loop memory 2, a high-capacity buffer memory embodied as a flash type device 3, and a durable, long-term, data store memory 4.

Is not merely the unique arrangement of these three memories and the fashion by which they are in communication with one another which makes up the essence of these inventions, but rather, it is important to consider the couplings between these memories and mechanisms by which data transfers occur between these memories.

As mentioned, the first memory is arranged as a managed loop memory. Images from the video camera are continuously recorded in the managed loop memory in a step which overwrites old data which is no longer needed. In some simple arrangements, this managed loop 5 is provided as a FIFO or ‘first-in, first overwritten’ scheme. In preferred high-performance arrangements, the managed loop is embodied as a timeline dilation scheme. All video data collected by the camera is stored only in the managed loop memory until a time when an event trigger 6 occurs. When an event trigger occurs, a memory transfer operation is executed. Data in the managed loop memory is transferred to a high-capacity buffer memory in response to an event having been detected. Thus the relationship between the managed loop memory and the high-capacity buffer memory can be characterized in that they are coupled by way of the event trigger which causes a transfer of data therebetween.

Flash memory has a capacity which may accommodate video data associated with several events. While flash memory is suitable for preserving data collected throughout the vehicle service day, it is not unlimited, nor permanent and data stored there is preferably transferred to a more durable long-term memory. Thus the high-capacity buffer memory is coupled to a durable data store by way of a proximity trigger 7. When the vehicle returns to download station (parking facility) at the end of the day, the proximity trigger detects that a vehicle has arrived at the download station and causes a wireless transfer 8 of data between the high-capacity buffer memory and the data store. The proximity trigger may be embodied within a wireless communications system whereby the mere presence of a vehicle in a designated parking lot causes a download transaction to occur automatically.

In review, video data from a video camera is continuously put into managed loop memory until an event trigger occurs which causes a data transfer from the managed loop memory to a flash type memory buffer. The flash memory has suitable capacity to accommodate several of these data transfers each being associated with a different event. Finally, when the vehicle returns to an appropriate download station a proximity trigger causes all data in the high-capacity buffer to be transferred to a network memory more durable and permanent in nature.

It is again noted that these inventions not only include three stages of particular memory configuration uniquely arranged in communication with one another, but in addition, include mechanism by which memory transfers occurs between these stages. More particularly, attention is drawn to the primary elements herein described as the event trigger and the proximity trigger. An event trigger is a system provided to sense and detect occurrence of some event of interest. An event of interest may be for example an automobile traffic accident. In this case accelerometers respond to abrupt changes in motion and provide the video event recorder with a signal to indicate that video data should be preserved and transferred to the high capacity buffer memory. While accelerometers provide excellent means of detecting abrupt motion in vehicles, there are additional systems which operate as useful event triggers. For example, a user initiated system may include a tactile switch which may be voluntarily engaged or operated by a user to indicate that some video sequence should be preserved. Thus, a so-called “panic button” system may operate as an event trigger as well as accelerometers.

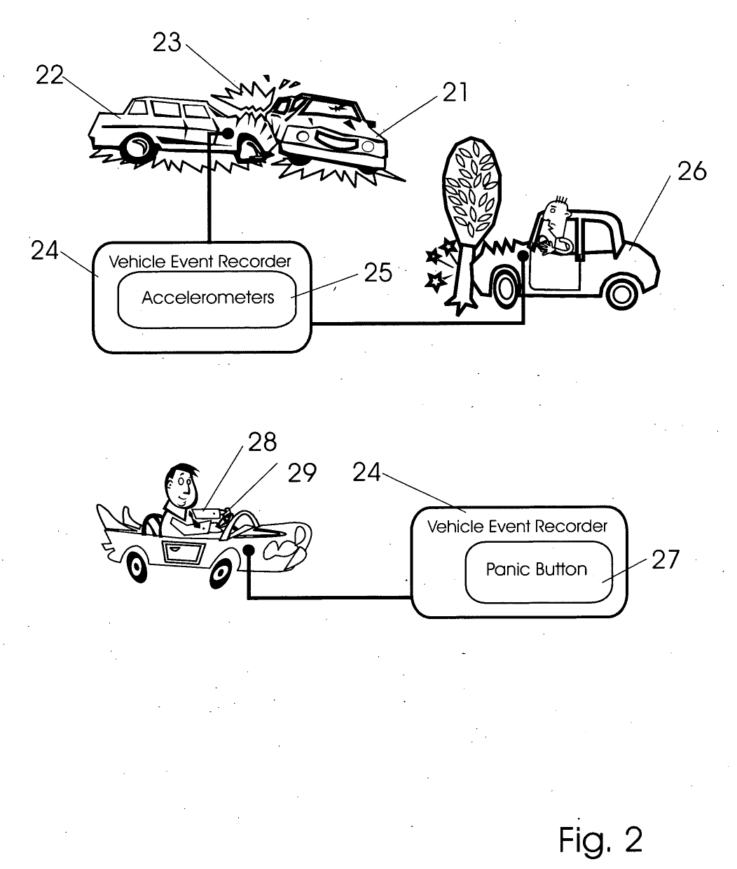

With reference to FIG. 2, a traffic accident between two automobiles car 21 and car 22 equipped with a vehicle event recorder system 24 having accelerometers 25 arranged as an event trigger. When a collision 23 occurs, the accelerometer initiates a data transfer between managed loop memory and a buffer memory to preserve video data collected immediately before and after the traffic accident. In similar fashion, car 26 equipped with a vehicle event recorder and accelerometer type event trigger illustrates that video of single vehicle accidents are captured as well.

In another scenario, a vehicle event recorder system equipped with a “panic button” type event trigger 27 may be engaged manually by a driver 28. When a driver sees some event which he determines should be recorded, he pushes a tactile button 29 arranged as an event trigger to initiate a data transfer between managed loop memory and buffer memory to preserve video associated with the observed event.

Thus event triggers of these inventions may be fully automated such as accelerometers or may also include manual type event triggers such as those embodied as panic buttons. In either case, a signal is provided to the system which causes data in the managed loop memory to be preserved and transferred to the buffer memory where it may be temporarily preserved.

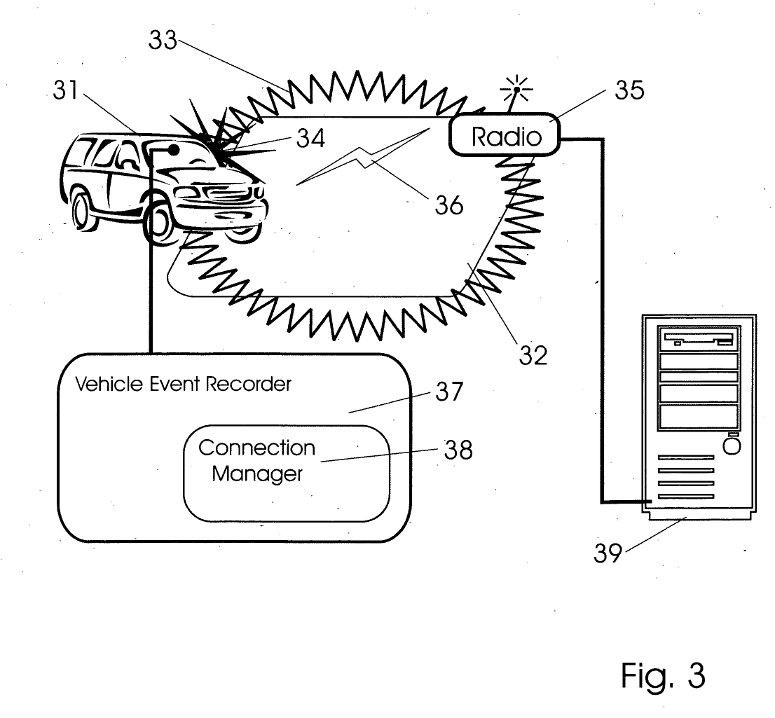

The above examples with reference to the drawings describe how video data is transferred from a first stage memory to a second stage memory; both of these memories being on-board memory. The following description is directed to the relationship between the on-board buffer memory and a long-term durable data store which may be maintained as part of a remote network system. Of particular importance in these systems, is a proximity trigger arranged to detect a proximal relationship between a vehicle event recorder and a communications station and further causes data in an on-board memory to be transmitted wirelessly to a network data store. FIG. 3 illustrates. A vehicle 31, returns at the end of a service day to a special parking facility 32. The parking facility is equipped with necessary equipment and communications means to serve as a data download facility. A communications space 33 which envelopes the parking area is served with a wireless communications system such as WiFi radio or other radio with suitable communications protocol. When the vehicle enters 34 this communications space this condition is detected by a proximity trigger which then the initiates a download action. A radio communications system 35 defines the extent of the communications space by way of its range. When a vehicle pierces the boundary of the communications space, data in the on-board buffer memory is transferred wirelessly 36 to a more permanent data store automatically without input or explicit action from the driver. This is achieved because the vehicle event recorder 37 is equipped with a connection manager module 38. The connection manager, detects the presence of a radio signal and negotiates an authorized communications connection with the radio server. When a proper communications link is established, data is passed from the on-board buffer memory to server 39 where data may be stored indefinitely or used in further processes or analysis.

It is useful to point out special versions of these systems which include the public Internet. Vehicle 41 enters download space 42, merely by entering 43 the communications space served by radio 44. Vehicle even recorder 45, includes connection manager 46 comprised of proximity trigger 47. The proximity trigger may include a radio signal strength detector to indicate a vehicle has entered into the communications space. Upon entry, video data is passed from an on-board memory to a remote system, which has no particular location relationship with the download station. That is, the third stage memory may be located anywhere within the network. A communications station need only be connected to the Internet. A remote server 48 arranged to facilitate download operations can be anywhere in the world. Such remote server can be in further communication with a mass data store 49 such as a redundant disk array.

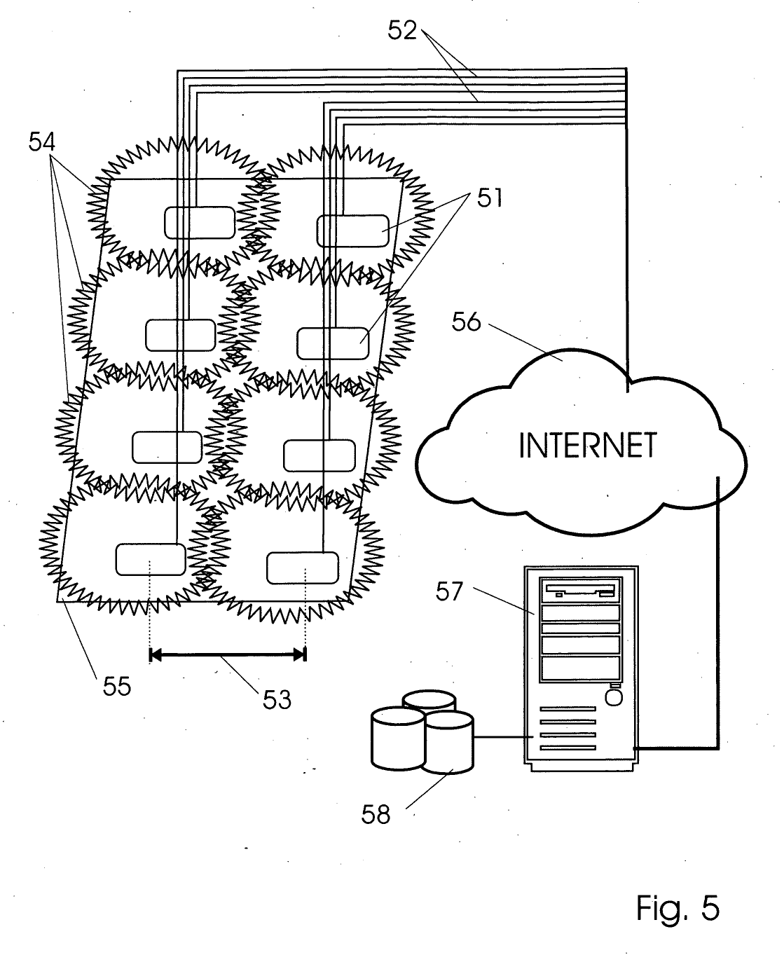

Since proximity trigger systems depend on the extent of a communications space, it is useful to further consider means which gives rise to this space. Namely, a radio transmitter or network of radio transmitters which have finite and limited service range. To establish an extended communications space, it is possible to arrange a plurality of radio transmitters each displaced in position with respect to another to form an array. FIG. 5 illustrates an advanced communications space having such extended range and associated array of radio transmitters. A plurality of radio transmitters 51 may each be coupled to the Internet by hardwire connection 52. Each radio transmitter may be separated from another by a distance 53 to provide a spatially distributed arrangement of radio transmitters. Each radio transmitter having a communications range 54 associated therewith operates together in conjunction with the others to provide a large space coverage. An extended parking lot 55, may be as large as several acres and suitable for accommodating hundreds of automobiles. When a vehicle equipped with a vehicle event recorder as described in these inventions enters the parking lot, a proximity trigger detects the proximity and initiates a download action where data in an on-board buffer memory is transmitted into the Internet 56 and further to a specially arranged download server 57 and permanent data store 58.

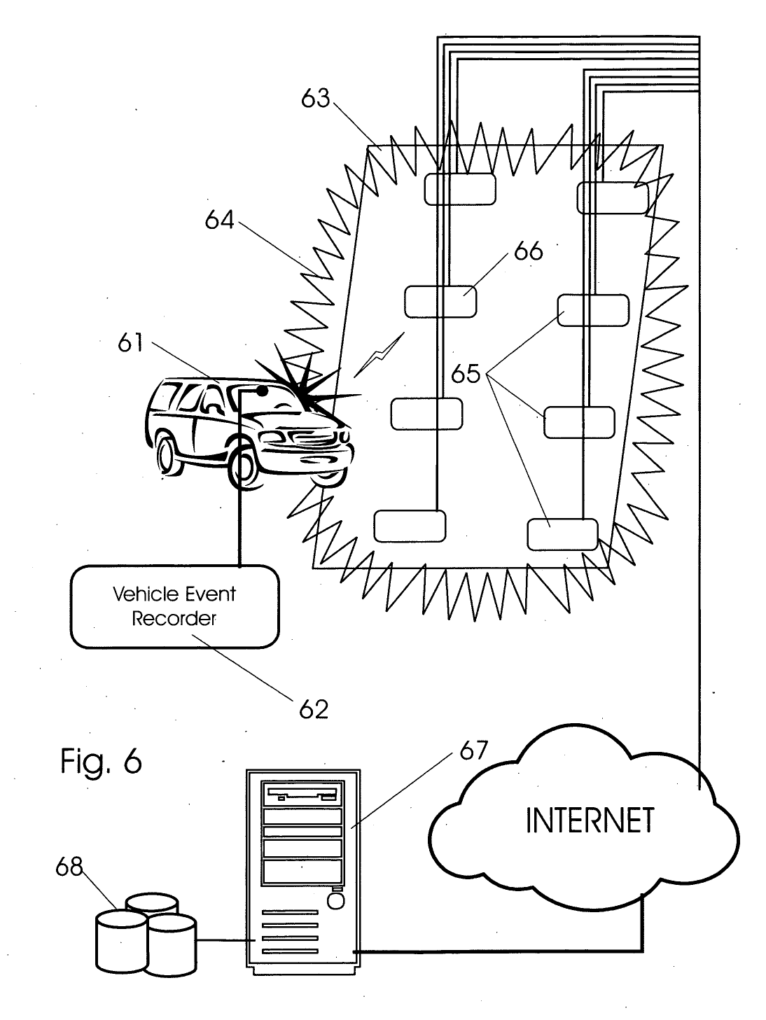

A more complete understanding of this is realized in view of FIG. 6 which illustrates vehicle 61 with a video event recorder 62 entering an extended communications space. When a vehicle drives onto the large parking lot 63, it pierces the communications envelope 64 to fire the proximity trigger. Distributed radio transmitters 65 forming a transmitter array are each available for communication with a cooperating radio of the vehicle event recorder system. Recorded video data is passed from an on-board memory in the vehicle event recorder to at least one nearby radio 66 in the radio network. Video data information is further passed, for example, by way of the Internet, to server computer 67, and still further to durable data store 68.

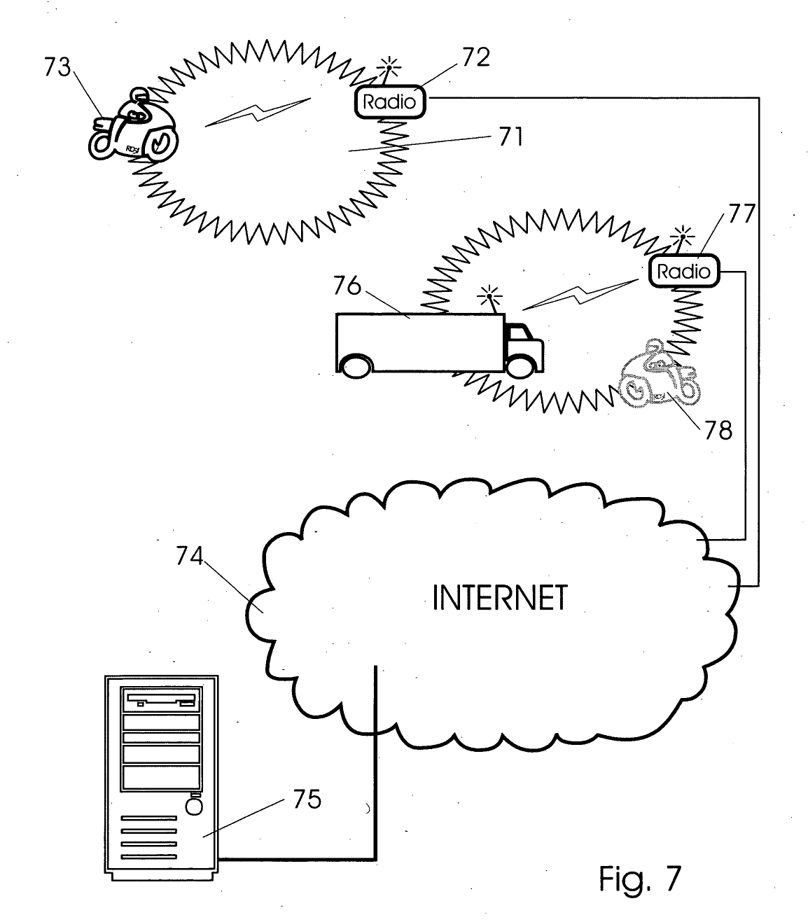

FIG. 7 illustrates an important aspect of these inventions which relates to separate communications spaces coupled to a single server. A first communications space 71 is established by radio transmitter 72. A particular vehicle 73 associated with this particular communications space, may enter the space to cause an automated video data transfer by way of proximity trigger. Video data is passed via the Internet 74 to remotely located server 75 for safe and long-term storage. An unrelated vehicle 76 having no relationship whatever with the first vehicle 73 may enter a different communications space established by radio transmitter 77 to similarly cause an automated download a video data to the same server. It is an important feature of proximity triggers of these inventions that particular vehicles and particular communications spaces may be coupled to a single server but that the vehicle event recorders communicate independently with their appropriate communications space. That is, a proximity trigger can be arranged to be responsive in a first communications space, but not responsive in another unauthorized communications space. Thus an unauthorized vehicle 78 enters the communications space associated with radio transmitter 77, the vehicle 78 not being a member of that communications space, would not be able to do a data download action there. The proximity trigger of vehicle 78, may detect a radio signal from transmitter 77, but no authorization for establishment of a communications link would be available. It is the function of a connection manager to only establish communications links when proper authorization is established.

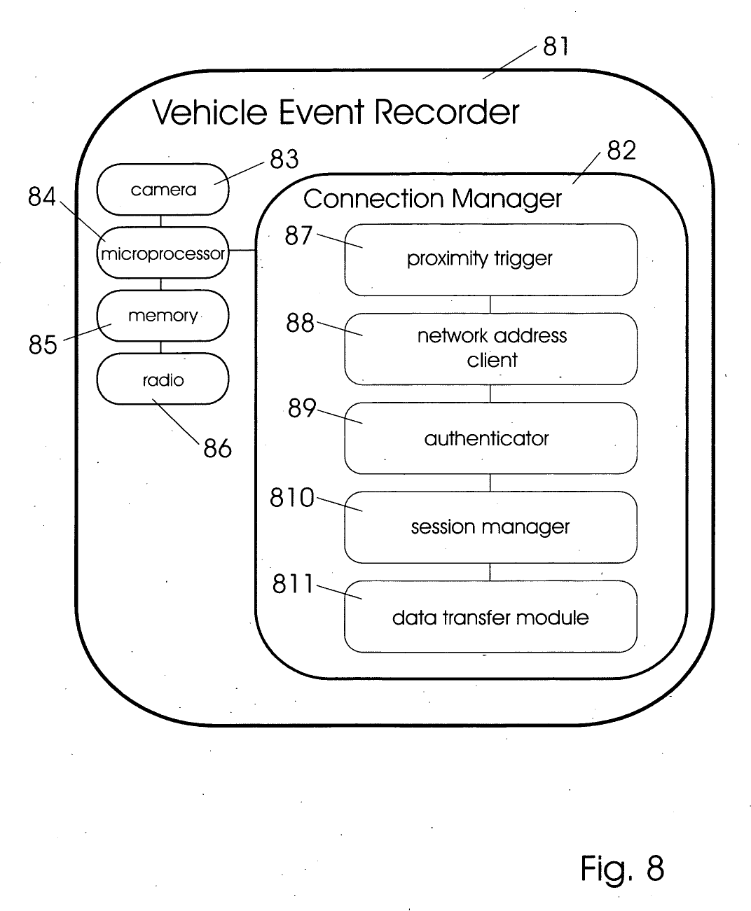

The entirety of these vehicle event recorder systems is better understood in view of the illustration of FIG. 8 which is a block diagram particularly detailing the connection manager. A vehicle event recorder 81 is a system to be mounted within the vehicle and includes at least a connection manager 82, camera 83, microprocessor 84, memory 85, and a radio transmitter 86. The connection managers further comprised of a proximity trigger 87, a network address client 88, and authenticator 89, a session manager 810, in a data transfer module 811. When the vehicle event recorder mounted in a vehicle enters a communications space, the proximity trigger detects such condition and solicits from the radio server an assignment of a network address. Once a network address is assigned the authenticator provides necessary handshaking to identify the particular vehicle event recorder to the communications station whereby authorization can be established. Once proper authorization is established, a session manager organizes transfer of data to and from the vehicle event recorder with respect to the network. A data transfer module includes means for transmitting data from the vehicle event recorder to the network, and may additionally include means for transmitting data in the other direction. Firmware updates from the server may be passed to the vehicle event recorder among other information useful at the vehicle event recorder.

In review, primary elements of vehicle event recorders of these inventions include a three stage memory system comprising: a managed loop memory in communication with a buffer memory by way of an event trigger; the buffer memory being in communication with a permanent data store by way of a proximity trigger. Data captured at a video camera is continuously written to the managed loop memory until an event trigger causes a data transfer of video information associated with a particular event to the on-board buffer memory. When a vehicle drives into a predetermined communications space, a proximity trigger activates a further download from the buffer memory to a permanent data store.

While described systems and examples are presented in great detail, is useful to further consider the primary elements of these systems independently with continued description as follows:

Managed Loop Memory

A managed loop memory is arranged to capture video data of very limited time periods. For example, a managed loop memory can be arranged to capture only 120 frames of video data captured at four frames per second. Thus, the capacity of a managed loop memory may only be associated with a video timeline of 30 seconds. When this memory is full, i.e. after thirty seconds of video, the old data in the memory is necessarily discarded and overwritten.

Managed loop memory may be embodied as semiconductor memory, for example as a DRAM type volatile memory. DRAM memory has the advantage that it is quite fast and suitable for use in conjunction with video systems, which tend to produce large amounts of data in short periods of time. Since a managed loop memory, is one which will be subject to millions of re-write operations over the course of a lifetime, selection of the particular physical system must consider the large number of rewrite operations. DRAM is suitable for use in this fashion. Flash memory, while new modern versions are becoming very fast, suffers from the fact that it can only be rewritten a few million times. Thus, flash type memory is not particularly suitable for use in a managed loop memory system.

Another alternative is possible. Ferroelectric memory systems are now commercially available which have sufficient speed, rewrite lifetime, and capacity to serve these video systems. While not as common as DRAM, Ferroelectric memory systems are becoming more mainstream. These high-performance memories are available off-the-shelf and can be deployed with vehicle event recorder systems as a managed loop memory. These memories have the advantage that they are non-volatile. This is particularly useful in vehicle accidents of a severe nature where a total loss of power results in loss of video data stored in memory. DRAM systems may fail to preserve most important data in this way. Ferroelectric systems however, capture full detail of events up to the time when power is lost.

Managed loop memories of these inventions are arranged to continuously capture video data. When the memory is full and new video data continues to be received, old video data is written over in a loop operation. The loop may be arranged as a FIFO loop, where the first data in is the first data to be overwritten. Such system is well known in the loop memory arrangements of the arts. Because of the special nature of vehicle event recorder systems, it is sometimes desirable to capture video at various frame rates surrounding a particular event. That is, at some point in time such as when a vehicle accident occurs it is preferred that video is captured at a maximum frame rate. At times further from an event moment, it is acceptable to collect video at reduced frame rates. A non-FIFO managed loop system may be deployed with a special overwrite scheme to effect various frame rates to preserve data in an extended timeline fashion. This is particularly useful where managed loop memories are of limited size.

High-Capacity Buffer Memory

A high capacity buffer memory is preferably provided as a flash type memory system. Flash memory is cheap and lightweight. Very inexpensive devices can hold enough video data to accommodate a great plurality of events. That is, a single cheap flash memory can hold the video data of 40 or more 30 second events. While not infinitely re-writable, flash may be re-written over a million times and so it serves well to use flash memory in these systems second memory stage, the high capacity buffer.

Flash memory buffers are coupled to managed loop memory whereby it is available on receipt of signal from an event trigger to copy data from the managed loop memory and store it for extended time periods.

It is alternatively possible to arrange a buffer memory system about a micro disk drive system. Small disk drives are available such that they may cooperate with these small footprint vehicle recorder systems. Disk drive memories have very high capacity suitable for a memory arranged as a buffer which can accommodate a plurality of events. However, disk drives remain a bit too expensive and sensitive to shock. While these may serve as alternatives, flash memory systems appear to have advantages not found in disk drive systems.

Permanent Data Store

A database may be arranged as a remote durable system which can accommodate a nearly infinite data set of many millions of video events. These durable memory systems may include backup means of redundant arrays of independent disks. Such data stores may be remotely located with respect to any download and communications spaces associated with particular vehicle event recorders. A single permanent data store may be in communication with a great plurality of vehicle event recorders. Permanent data store facilities of these inventions are related to various buffer memories in that a transfer of video data from the buffer memory to permanent data store occurs in response to a proximity trigger which detects the presence of a vehicle event recorder in a predetermined communications space.

Event Trigger

An event trigger is a mechanism which detects a prescribed physical condition and sets a data transfer action into motion in response thereto. An event trigger causes a data transfer between a managed loop memory stage and an on-board buffer memory stage. An event trigger may be arranged to detect a condition such as an automobile crash. When a car crashes, it generally suffers an abrupt motion detectable via motion transducers such as accelerometers. As such, an accelerometer can provide a signal to cause a data transfer in response to a traffic accident.

It is possible to arrange an event trigger as responsive to aggressive driving such as abrupt swerving motions. Event triggers might be arranged in conjunction with excessive braking maneuvers. Thus, not only accidents but other general vehicle misuse might be captured in recorded video as various types of event triggers cause data to be transferred to a buffer and preserved. Another physical condition suitable for use as an event trigger is that a user push button has been activated. Event triggers may also be arranged in conjunction with position detectors and timers. A position detector could be set to capture a video series at any of pre-selected locations determined of interest. A GPS detects that a vehicle is in a particular prescribed location (for example a known dangerous intersection) a trigger event can be fired in response thereto. Similarly, a timed event trigger could be activated on a preset time interval for some versions.

Proximity Trigger

When a vehicle enters a predetermined communications space, a proximity trigger can detect that condition and initiate a data transfer between the on-board buffer memory and a network data store.

A proximity trigger is embodied as part of a connection manager system. A vehicle event recorder includes a module which manages wireless communications connections between the vehicle event recorder and a computer server system. A proximity trigger may respond to detection of a radio signal of predetermined strength. When a vehicle enters a space in which radio communications service is available, the proximity trigger can set forth a download action where data is transferred from the buffer to the network data store. A proximity trigger may be arranged with respect to a large area communications space. A group of radio transmitters might cooperate together to form a single space which operates in conjunction with the proximity detection. Thus a proximity trigger can be arranged to detect when a vehicle event recorder is within a large communications space served by several radios each having their own and separate radio signal.

Additional important elements of these vehicle recorder systems include the systems characterized as a connection manager. A connection manager is a module within a vehicle event recorder which manages communications connections with authorized radio transmitters. A connection manager is comprised of a proximity trigger; a network address client; authenticator; session manager; and a data transfer module. A network address client is a system which receives a network address assignment. When a vehicle event recorder comes into contact with a communications space, it attempts to make a communications connection with the radio. A first step includes assignment of a unique network address to the vehicle event recorder. In this way, the network can more efficiently exchange messages with the vehicle event recorder. While a simple DHCP client is preferred, other forms of network address management may suffice. Alternatives include: Appletalk, IPX; BOOTP; or RARP among others.

An authenticator is provided to assure data transfers occur only between authorized parties. Once a network address is established, a vehicle event recorder attempts to log-in to the system by identifying itself and providing a credential. If the credential is accepted, and log-in is permitted, then a session manager initiates a communications session. A communications session includes data transfer both to and from the vehicle event recorder. A data transfer module includes a routine to flush the on-board data buffer and transmit the video information contained therein to a permanent data store. Data may also be uploaded to the vehicle recorder system including matters such as firmware updates, traffic and road condition information, et cetera. After data is appropriately transferred, the session manager does housekeeping tasks to close the communications link, clear and reset the memory for use another day, and indicate a completed and successful transaction has occurred permitting the vehicle to leave the communications space freely.

The examples above are directed to specific embodiments which illustrate preferred versions of devices and methods of these inventions. In the interests of completeness, a more general description of devices and the elements of which they are comprised as well as methods and the steps of which they are comprised is presented here following.

### GENERAL DESCRIPTIONS OF APPARATUS OF THESE INVENTIONS—IN REVIEW

In most general terms, apparatus of these inventions may precisely be described as including:

A multi-stage video memory management system including: a managed loop memory, a high-capacity buffer memory, a permanent data store, an event trigger; and a proximity trigger. The managed loop memory continuously receives video data from a video camera and records such data in real-time. The high-capacity buffer memory receives from time-to-time in response to an event trigger, data from managed loop memory. The permanent data store is a mass memory of high durability and capacity suitable for long-term storage. This data store is sometimes in communication (for example by radio) with the high-capacity buffer memory such that video data is transferred in response to the proximity trigger.

While the immediately preceding description is directed to the most essential elements, it is important to consider these elements in relation to the more complete system which may be generally described as follows:

Vehicle event recorder systems including: a camera arranged to convert optical signals to electronic signals, memory, a radio transceiver, a connection manager, and a microprocessor. The microprocessor is connected to the camera to receive electronic image signals in video series. The microprocessor manages the memory whereby processed electronic signals are written to and stored. The microprocessor also transfers data stored in memory to external systems via the radio transceiver(s).

A connection manager includes: a proximity detector; an network address client; an authenticator; a session manager; and a data transfer module. The proximity detector is arranged to detect whether the system is near a prescribed communications space radio such that a connection may be established and a network address assigned. An authenticator includes mechanism responsive to a connection having been made and provides determination whether communication is with a recognized and approved entity. A session manager is arranged to establish a communications connection with a downloader service hosted at a remote server and to initiate data transfer. A data transfer module includes means to convey recorded data in the vehicle event recorder memory to a remote server.

One will now fully appreciate how various memory systems may be deployed and put in communication with each other to effect a highly efficient memory management system in view of specific applications and objectives relating to vehicle recorder systems. Although the present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) A multi-stage video memory management system comprising:
a managed loop memory;
a high-capacity buffer memory;
a permanent data store;
an event trigger; and
a proximity trigger,
said managed loop memory arranged to continuously receive video data from a video camera and record this data in real-time,
said high-capacity buffer memory has a capacity at least three times managed loop memory, is coupled to said managed loop memory such that video data may be transferred from the managed loop memory to the high-capacity buffer memory in response to said in event trigger;
said permanent data store being a mass memory of high durability and capacity suitable for long-term storage coupled to said high-capacity buffer memory such that video data may be transferred from the high-capacity buffer to the permanent data store in response to said proximity trigger.

2) A video memory management system of claim 1, said event trigger is an electronic signal generated as an indicator that a prescribed event has occurred.

3) A video memory management system of claim 2, said prescribed event is further defined as a vehicle collision.

4) A video memory management system of claim 2, said event trigger includes a motion sensor and a threshold, whereby when said threshold is exceeded the trigger is toggled and provides a binary output to indicate that state thus causing a data transfer.

5) A video memory management system of claim 2, said event trigger includes a panic button, whereby when said panic button is engaged the event trigger is toggled and provides a binary output to indicate that state thus causing a data transfer.

6) A video memory management system of claim 1, said proximity trigger is an electronic signal generated as an indicator that a prescribed proximity condition exists.

7) A video memory management system of claim 6, said proximity trigger is a mechanism which detects the proximity between a vehicle event recorder and a download station and provides a signal to initiate a data transfer from the high-capacity buffer to the permanent data store.

8) Vehicle event recorder systems comprising:
at least one video camera arranged to convert optical signals to electronic signals;
rewritable memories operable for storage of digital data;
a radio transceiver;
a connection manager; and
a microprocessor,
said microprocessor is coupled with said camera whereby the microprocessor receives electronic signals from the camera, and further coupled to said memories whereby processed electronic signals may be written to and stored in said memories and further coupled such that the microprocessor can transfer data stored in said memories to an external data storage system via said radio transceiver, said connection manager is arranged to detect whether the vehicle event recorder is near a communications space radio whereby a communications connection may be established, and further to initiate data transfer to move recorded data in the rewriteable memories to a remote server.

9) Vehicle event recorder systems of claim 8, said rewritable memories include a managed loop memory and a high capacity buffer memory.

10) Vehicle event recorder systems of claim 9, data is transferred from said managed loop memory to said high capacity memory in response to an event trigger signal.

11) Vehicle event recorder systems of claim 8, said connection manager is comprised of:
a proximity detector;
an network address client;
an authenticator;
a session manager; and
a data transfer module,
said proximity detector arranged to detect whether the VER is near a communications space radio whereby a communications connection may be established,
said network address client operable for soliciting and receiving a network address,
said authenticator comprising a mechanism responsive to receipt of a network address which provides a determination whether a communication is with a recognized and approved entity,
said session manager is arranged to establish a communications connection with a downloader service hosted at a remote server and to initiate the data transfer module, and
said data transfer module includes means to move recorded data in the rewriteable memory to remote server.

12) Vehicle event recorder systems of claim 11, said proximity detector includes a signal strength threshold which determines the vehicle event recorder is receiving a signal of the type used in a communications space and is proximate enough to maintain a communications connection.

13) Vehicle event recorder systems of claim 11, said proximity detector is a position determining means which determines whether or not the vehicle event recorder is in a predetermined position which corresponds to a communications space.

14) Vehicle event recorder systems of claim 11, said proximity detector includes a binary output arranged to activate the authenticator.

15) Vehicle event recorder systems of claim 11, said network address client is fashioned as a DHCP client.

16) Vehicle event recorder systems of claim 11, said session manager is arranged to contact a server via the Internet.

17) Vehicle event recorder systems of claim 14, said session manager contacts a server via TCP/IP and XML web transactions.

18) Vehicle event recorder systems of claim 11, said session manager further includes means to close the communications connection with the remote server and return the systems to a ready state where said memories are flushed and renew for further use.

19) Vehicle event recorder systems of claim 11, said data transfer module further includes means to delete local memory after a successful transfer has occurred.

20) Methods of transferring vehicle event video data captured at an incident scene to a remote server comprising the steps:
capturing a time series of images in the camera of a vehicle event recorder;
storing said series of images in a rewritable, non-volatile memory of the vehicle event recorder,
moving the vehicle to a communications space whereby a radio transceiver of the vehicle event recorder is proximate to the transceiver of the communications space and a connection may be established,
providing a communications connection between the vehicle event recorder and the server,
transferring data from said vehicle event recorder to a remote server, and
termination said communications connection in response to a successful download.

21) Methods of claim 18, further comprising the step rewriting video data to a loop memory whereby expired data is replaced by newly captured data.

22) Methods of claim 19, further comprising the step transferring video data from said loop memory to buffer memory in response to a signal provided by an event trigger.
